(19) United States
(12) Patent Application Publication
(10) Pub. No.: US 2009/0245691 A1
(43) Pub. Date: Oct. 1, 2009

(54) ESTIMATING POSE OF PHOTOGRAPHIC IMAGES IN 3D EARTH MODEL USING HUMAN ASSISTANCE

(75) Inventors: Michael Naimark, Long Island City, NY (US); William Berne Carter, Los Angeles, CA (US); Paul E. Debevec, Marina del Rey, CA (US); James Perry Hoberman, Los Angeles, CA (US); Andrew Jones, Los Angeles, CA (US); Bruce John Lamond, Los Angeles, CA (US); Erik Christopher Loyer, Valencia, CA (US); Giuseppe Mattiolo, Bromley (GB)

Correspondence Address: MCDERMOTT WILL & EMERY LLP, 2049 CENTURY PARK EAST, 38th Floor, LOS ANGELES, CA, 90067-3208, US

(73) Assignee: UNIVERSITY OF SOUTHERN CALIFORNIA, Los Angeles, CA (US)

(21) Appl. No.: 12/415,145

(22) Filed: Mar. 31, 2009

Related U.S. Application Data
(60) Provisional application No. 61/041,114, filed on Mar. 31, 2008.

(51) Int. Cl. G06K 9/36; G06T 15/00

(52) U.S. Cl. 382/285; 345/419

(57) ABSTRACT

The pose of a photographic image of a portion of Earth may be estimated using human assistance. A 3D graphics engine may render a virtual image of Earth from a controllable viewpoint based on 3D data that is representative of a 3D model of at least a portion of Earth. A user may locate and display a corresponding virtual image of Earth at a viewpoint that approximately corresponds to the pose of the photographic image by manipulating user controls. The photographic image and the corresponding virtual image may be overlaid on one another so that both images can be seen at the same time. The user may adjust the pose of one of the images while overlaid on the other image by manipulating user controls so that both images appear to substantially align with one another. The settings of the user controls may be converted to pose data that is representative of the pose of the photographic image within the 3D model.

### CROSS-REFERENCE TO RELATED APPLICATION(S)

This application is based upon and claims priority to U.S. Provisional Patent Application No. 61/041,114, entitled “Seamless Image Integration into 3D Models,” filed Mar. 31, 2008, attorney docket number 028080-0333. The entire content of this provisional patent application is incorporated herein by reference.

### BACKGROUND

1. Technical Field

This disclosure relates to image processing and, in particular, to superimposing 2D images in 3D image models of Earth.

2. Description of Related Art

U.S. patent application Ser. No. 11/768,732, entitled, “Seamless Image Integration into 3D Models,” filed Jun. 26, 2007, enables a community of users to upload 2D photographic images of particular locations on Earth and to superimpose these within a 3D model of Earth. This may be done in such a way that the photographic images appear as perfectly aligned overlays with the 3D model. The entire content of this patent application is incorporated herein by reference, along with all documents cited therein.

To accomplish this, each photographic image may be displayed against a viewpoint of the 3D model (sometimes also referred to herein as the pose of the 3D model) which substantially approximates the pose of the photographic image. Unfortunately, determining the pose of the photograph image may not be an easy task. It may require as many as eight different variables to be determined, or even more.

This process may become even more difficult when the 3D model lacks details that are contained within the photograph image and/or when the corresponding viewpoint within the 3D model is otherwise significantly different. These differences between the photographic image and the corresponding viewpoint in the 3D model may make it very difficult for the pose of the photographic image to be determined, particularly when using solely automation.

### SUMMARY

A pose estimation system may estimate the pose of a photographic image of a portion of Earth. The pose estimation system may include a 3D graphics engine for rendering a virtual image of Earth from a controllable viewpoint based on 3D data that is representative of a 3D model of at least a portion of Earth; a computer user interface that includes a display and user controls having settings that can be set by a user; and a computer processing system associated with the 3D graphics engine and the computer user interface. The computer processing system and the user interface may be configured to display the photographic image on the display; allow the user to locate and display a corresponding virtual image of Earth at a viewpoint that approximately corresponds to the pose of the photographic image by manipulating the user controls and by using the 3D graphics engine; display the photographic image and the corresponding virtual image overlaid on one another so that both images can be seen at the same time; allow the user to adjust the pose of the photographic image while overlaid on the virtual image by manipulating the user controls so that both images appear to substantially align with one another; and convert settings of the user controls to pose data that is representative of the pose of the photographic image within the 3D model.

The pose estimation system may include a computer storage system containing the 3D data. The computer storage system may also contain the photographic image, and the photographic image may include information not contained within the corresponding virtual image. The photographic image may be sufficiently different from the corresponding virtual image that it would be very difficult to ascertain the pose of the photographic image within the 3D model using only automation.

The computer processing system may not have access to a 3D version of the corresponding virtual image.

The user interface and the computer processing system may be configured to present the user with a location-selection screen on the display. The screen may display in one area the photographic image and in another area a virtual image of Earth at the viewpoint dictated by settings of the user controls. This display may be updated while the user is trying to locate the corresponding virtual image of the photographic image by manipulating the user controls.

The user controls may include an interactive map of at least a portion of the 3D model and an icon on the interactive map. The user interface and the computer processing system may be configured to allow the user to locate the corresponding virtual image by moving the interactive map relative to the icon.

The user interface and the computer processing system may be configured to allow the use to specify the pan of the corresponding virtual image by rotating the icon relative to the interactive map.

The user interface and the computer processing system may be configured to present the user with a photo-point selection screen and to allow the user to select and store an alignment point on a displayed image of the photographic image.

The user interface and the computer processing system may be configured to present the user with a virtual-point selection screen and to allow the user to select and store an alignment point on a displayed image of the corresponding virtual image.

The user interface and the computer processing system may be configured to display the photographic image and the corresponding virtual image overlaid on one another with the selected alignment points on the photographic image and the corresponding virtual image overlapping.

The user interface and the computer processing system may be configured to allow the user to rotate and scale one image with respect to the other image by manipulating settings of the user controls while the selected alignment points overlap so as to better align the two images.

The user interface and the computer processing system may be configured to allow the user to separately drag each of a plurality of points on a 3D version of the corresponding virtual image to a corresponding point on the photographic image while the two images are overlaid on one another so as to cause the two images to better align with one another after each point is dragged by the user.

The user interface and the computer processing system may be configured to allow the user to drag each of the plurality of points until the overlaid images are substantially aligned with one another.

Computer-readable storage media may contain computer-readable instructions which, when read by a computer system containing a 3D graphics engine, a computer user interface, and a computer processing system, cause the computer system to implement a process for estimating the pose of a photographic image of a portion of Earth.

A pose estimation process may estimate the pose of a photographic image of a portion of Earth.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings disclose illustrative embodiments. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it is intended to refer to the same or like components or steps.

FIG. 1 illustrates a pose estimation system.

FIG. 2 illustrates a pose estimation process.

FIGS. 3(a)-3(f) are screens in a pose estimation process. FIG. 3(a) is a screen that displays a selected photographic image. FIG. 3(b) is a screen that allows a user to locate and display a corresponding virtual image of Earth at a viewpoint that approximately corresponds to the pose of the selected photographic image. FIG. 3(c) is a photo-point selection screen that allows a user to select and store an alignment point on a displayed image of the photographic image. FIG. 3(d) is a virtual-point selection screen that allows a user to select and store an alignment point on a displayed image of the corresponding virtual image. FIG. 3(e) is a screen that displays the photographic image and the corresponding virtual image overlaid on one another with the selected alignment points on the photographic image and the corresponding virtual image overlapping and that allows the user to rotate and scale one image with respect to the other image to better align the two images. FIG. 3(f) is a screen that displays pose data derived from settings of the user controls.

FIG. 4 illustrates a process for adjusting the pose of a photographic image and/or a corresponding virtual image until the two are aligned.

FIGS. 5(a)-5(c) are screens which illustrate a photographic image placed in different ways within a corresponding virtual image. FIG. 5(a) is a screen which illustrates the photographic image placed below the corresponding virtual image. FIG. 5(b) is a screen which illustrates the photographic image superimposed on top of the corresponding virtual image with complete opacity. FIG. 5(c) is a screen which illustrates the photographic image superimposed on top of the corresponding virtual image with partial opacity.

FIG. 6 illustrates an alternate process for adjusting the pose of a photographic image and/or a corresponding virtual image until the two are aligned.

FIGS. 7(a)-7(d) are screens in an alternate pose adjustment process. FIG. 7(a) is a screen of a photographic image that has a substantially different scale and altitude than the viewpoint of a corresponding virtual image. FIG. 7(b) is a screen of the photographic image and the corresponding virtual image after a first point on the corresponding virtual image has been adjusted to match the corresponding point on the photographic image. FIG. 7(c) is a screen of the photographic image and the corresponding virtual image after a second point on the corresponding virtual image has been adjusted to match the corresponding point on the photographic image. FIG. 7(c) is a screen of the photographic image and the corresponding virtual image after a third point on the corresponding virtual image has been adjusted to match the corresponding point on the photographic image.

### DETAILED DESCRIPTION OF ILLUSTRATIVE EMBODIMENTS

Illustrative embodiments are now discussed. Other embodiments may be used in addition or instead. Details that may be apparent or unnecessary may be omitted to save space or for a more effective presentation. Conversely, some embodiments may be practiced without all of the details that are disclosed.

A photographic image may be taken of a scene on Earth.

The photographic image may have been taken at a particular location in space. This location may be identified by a latitude, a longitude, and an altitude. The photographic image may also have been taken at various angular orientations. These angular orientations may be identified by a pan (also known as yaw) (e.g., northwest), a tilt (also known as pitch) (e.g., 10 degrees above the horizon), and a rotation (also known as roll) (e.g., 5 degrees clockwise from the horizon).

The photographic image may also have a field of view, that is, it may only capture a portion of the scene. The field of view may be expressed as a length and a width. When the aspect ratio of the image is known, the field of view may be expressed by only a single number, commonly referred to as a scale, zoom, and/or focal length.

The combination of all of these parameters is referred to herein as the “pose” of the photograph.

The photographic image may also have other parameters. For example, the photographic image may have parameters relating to the rectilinearity of the optics, the “center of projection” in the image, and the degree of focus and resolution of the image. Many image capture devices, however, use center-mounted perspective lenses in which straight lines in the world appear straight in the resulting image. Many image capture devices may also have adequate resolution and depth of field. For these image capture devices, the pose may be specified without these secondary parameters. As used herein, the word “pose” may or may not include these other parameters.

Thus, the pose of a photograph image may typically require the specification of at least seven (if the aspect ratio of the image capture device is known) or eight (if the aspect ratio of the image capture device is not known) separate parameters.

Determining all of these parameters of a photograph image using a 3D model of Earth can be a challenging task. This may be particularly true when there are differences between the 3D model and the photograph image. For example, the photograph may contain artifacts or elements normally not found in the 3D model, such as shadows or other forms of lighting changes; weather-related, seasonal, or historical changes; foreground objects such as people, animals, or cars; or even artificially inserted material such as graphics or imaginary objects. These differences between the photographic image and the corresponding 3D model may make it very difficult for the pose of the photographic image to be determined using the 3D model and solely automation.

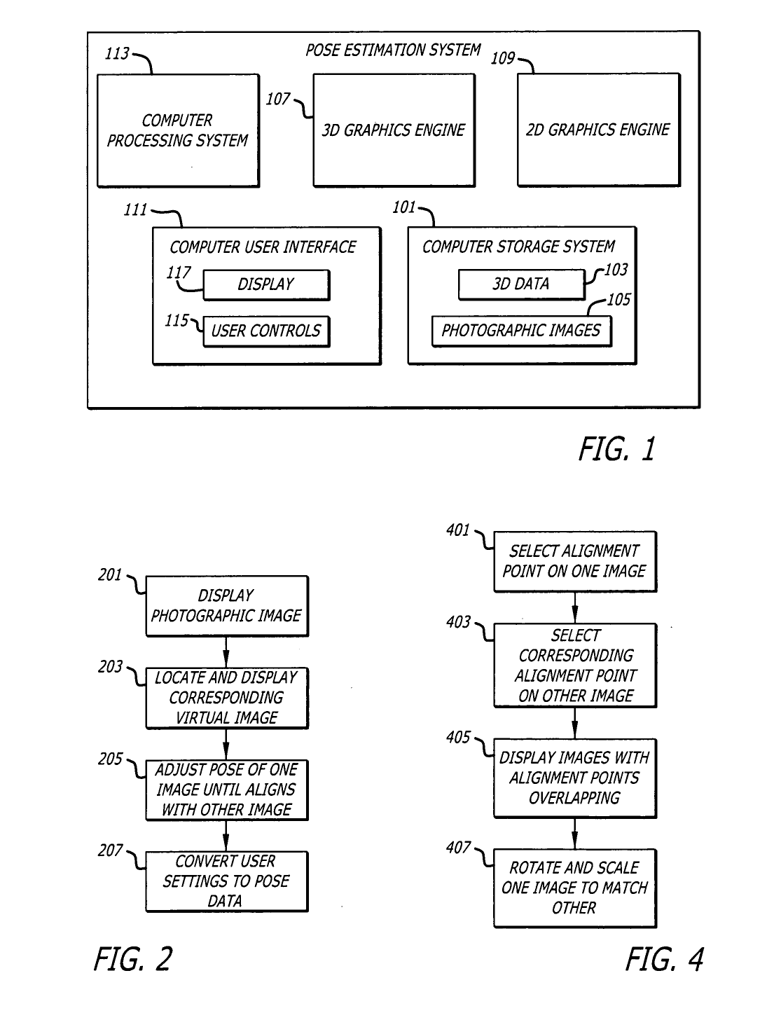

FIG. 1 illustrates a pose estimation system. As illustrated in FIG. 1, a computer storage system 101 may include three dimensional (3D) data 103 and one or more photographic images 105.

The computer storage system 101 may be of any type. For example, it may include one or more hard drives, DVD's, CD's, flash memories, and/or RAMs. When multiple devices are used, they may be at the same location or distributed across multiple locations. The computer storage system 101 may be accessible through a network, such as the internet, a local network, and/or a wide area network.

The 3D data 103 may be representative of a 3D model of anything, such as Earth or at least a portion of Earth. The 3D data may come from any source, such as Google Earth and/or Microsoft Live 3D Maps.

The photographic images 105 may be of any type. For example, they may include one or more photographs, each of a real-life scene on Earth. Each of these scenes may also be depicted within the 3D model that is represented by the 3D data 103.

One or more of the photographic images 105 may contain details of a scene which are different from or otherwise not contained within the details of the scene that are present in the 3D data. For example, the 3D data may contain data indicative of the overall shape of a building, but may not contain data indicative of windows or porches in the building, surrounding trees, cars, and/or persons. One of the photographic images 105, on the other hand, may contain some or all of these additional details. The information about the building which is portrayed in the 3D data 103, moreover, may not be as accurate as the corresponding information in one of the photographic images 105. As a consequence of these differences, it may be very difficult for the pose of one or more of the photographic images 105 within the 3D model to be determined purely by automation.

One or more of the photographic images 105 may consist of a single image and/or a sequence of images at the same pose, such as a video during which the camera is not moved. The photographic images may be represented by 2D data or 3D data.

One or more of the photographic images 105 may include a hierarchical set of tiles of the actual image at multiple resolutions.

The pose estimation system may include a 3D graphics engine 107. The 3D graphics engine 107 may be any type of 3D graphics engine and may be configured to render a virtual image of the 3D model contained within the 3D data 103 from a controllable viewpoint. The virtual image which the 3D graphics engine renders may be represented by 3D data or by 2D data which lacks any depth information.

The 3D graphics engine may include appropriate computer hardware and software, such as one or more computer processors, computer memories, computer storage devices, operating systems, and applications programs, all configured to access the 3D data 103 and to produce virtual images at specified viewpoints therein in one or more of the ways described herein, as well as in other ways. Examples of the 3D graphics engine 107 include Google Earth and Microsoft Live 3D Maps.

The pose estimation system may include a 2D graphics engine 109. The 2D graphics engine 109 may be configured to manipulate and display one or more of the photographic images 105. Like the 3D graphics engine 107, the 2D graphics engine 109 may include appropriate computer hardware and software, such as one or more computer processors, computer memories, computer storage devices, operating systems, and applications programs, all configured to access and manipulate the photographic images 105 in one or more of the ways described herein, as well as in other ways.

The 2D graphics engine 109 and the 3D graphics engine 107 may be at the same location or may be at different locations.

The pose estimation system may include a user interface 111. The user interface may include a display 117 and user controls 115 as well as any other type of user interface device. The user interface may be configured to be used by a user, such as by a human being.

The display 117 may be of any type. For example, it may be one or more plasma and/or LCD monitors.

The user controls 115 may be of any type. For example, the user controls 115 may include one or more mice, keyboards, touch screens, mechanical buttons, and/or any other type of user input device. The user controls 115 may include one or more on-screen controls, such as one or more menus, sliders, buttons, text boxes, interactive maps, pointers, and/or any other type of icon.

Each of the user controls 115 may include one or more settings which may provide one or more values, the selection of which may be controlled by operation of the user control by a user.

One or more of the user controls 115 may be part of a browser-based application.

The pose estimation system may include a computer processing system 113. The computer processing system 113 may include appropriate computer hardware and software, such as one or more computer processors, computer memories, computer storage devices, operating systems, and applications programs, all configured to cause the computer processing system to perform the operations that are described herein, as well as to perform other operations.

The computer processing system 113 may be configured to communicate with the computer storage system 101, the 3D graphics engine 107, the 2D graphics engine 109, and/or the computer user interface 111. The computer processing system 113 may be at the same location as one or more of these other sub-systems, or may be located remotely from one or more of them. The computer processing system 113 may communicate with one or more of these sub-systems by any means, such as through the internet, a local area network, a wide area network, and/or by a more direction communication channel.

The computer processing system 113 may or may not have access to the 3D data 103. In some configurations, the computer processing system 113 may only have access to a 2D data version of the virtual images which are generated by the 3D graphics engine 107. In other configurations, the computer processing system 113 may have access to a 3D data version of the virtual images which are generated by the 3D graphics engine 107.

The computer processing system 113 may be configured to communicate with one or more of the other sub-systems in the pose estimation system using protocols that are compatible with these other sub-systems. When the computer processing system 113 communicates with the 3D graphics engine 107 that is a part of Google Earth, for example, the computer processing system 113 may be configured to communicate with the 3D graphics engine 107 using protocols that are compatible with Google Earth, such as the PhotoOverlay KML, which may include the Camera KML element (specifying position and rotation) and the View Volume element (specifying field of view).

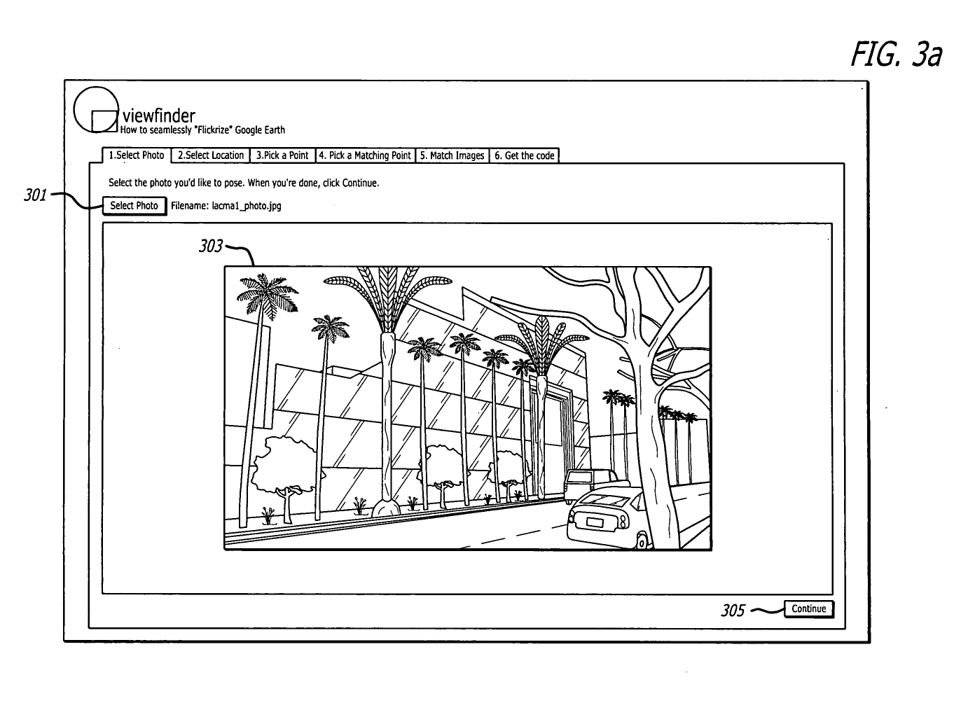

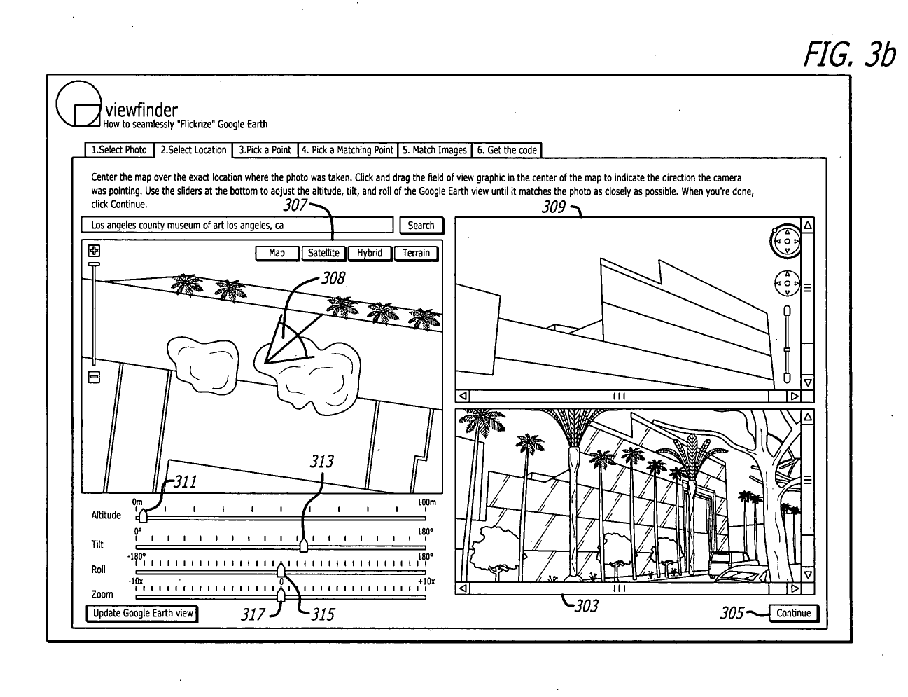

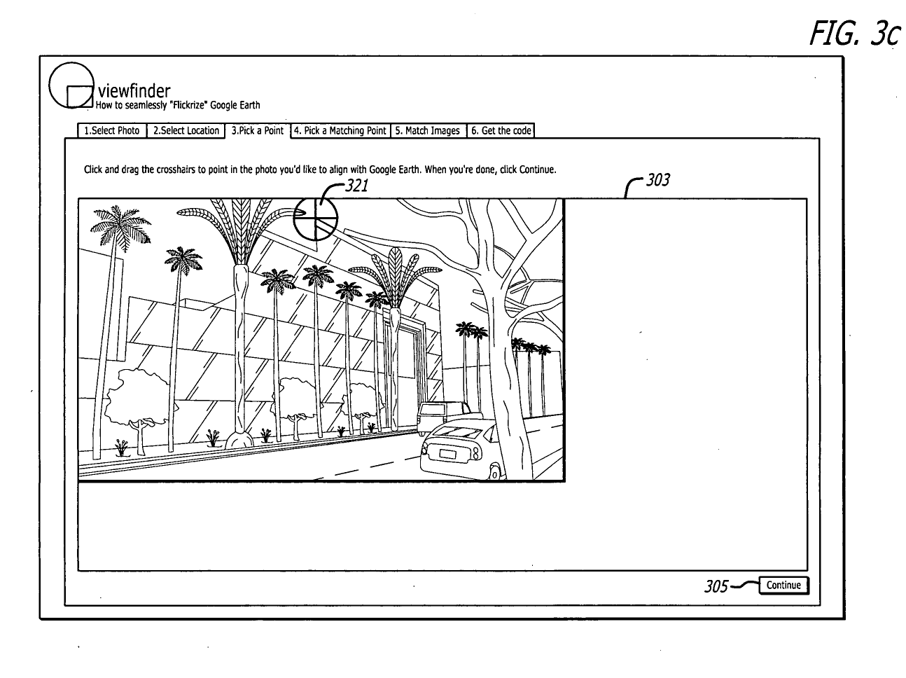

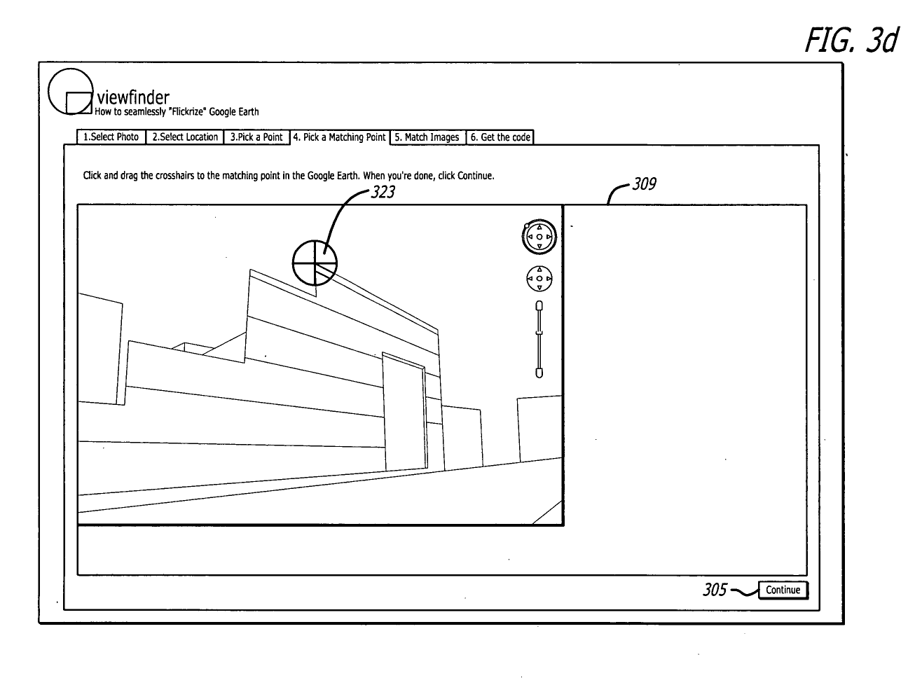

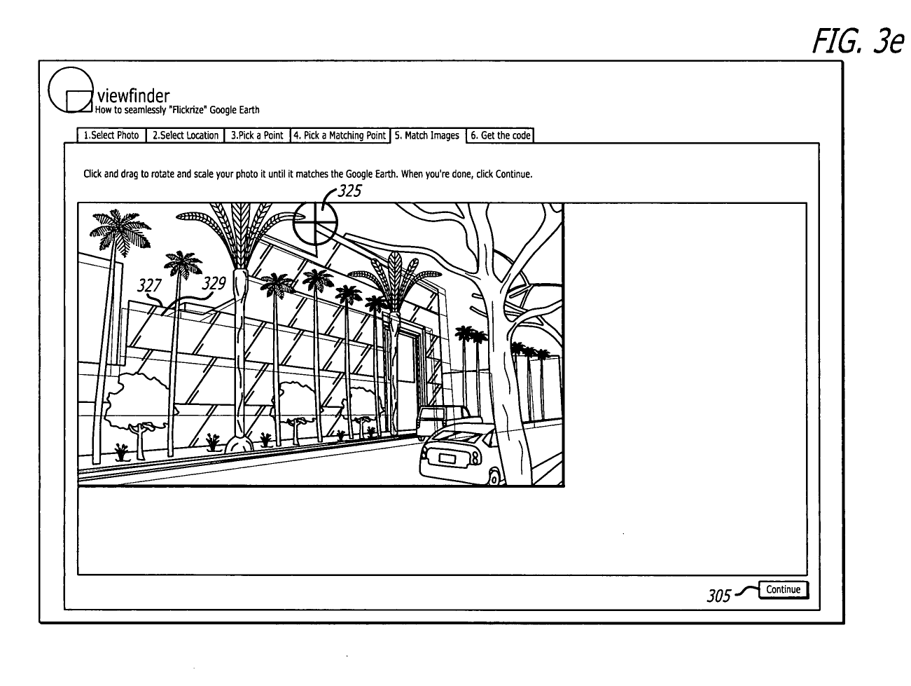

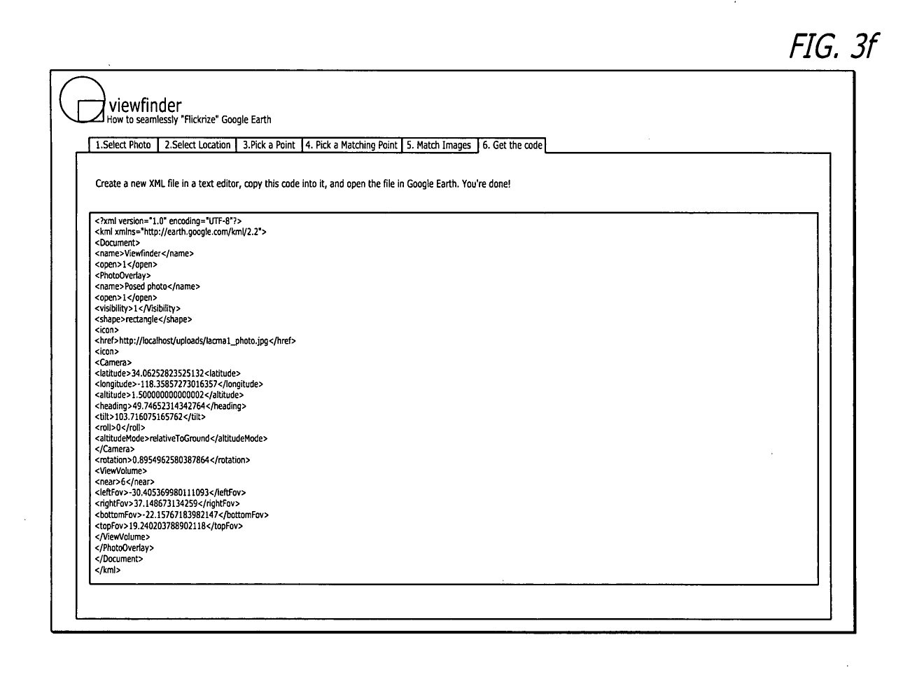

FIG. 2 illustrates a pose estimation process. FIGS. 3(a)-3(f) are screens in a photo estimation process. The process illustrated in FIG. 2 may be implemented in the screens in FIGS. 3(a)-3(f) as well as by different and/or additional screens. Similarly, the screens in FIGS. 3(a)-3(f) may implement processes other than the one illustrated in FIG. 2.

The pose estimation process may include a Display Photographic Image step 201. During this step, a particular photographic image may be uploaded and displayed. For example, a select photo button 301 in FIG. 3(a) may be pressed, following which a particular photographic image 303 may be selected. This may result in the selected photographic image 303 being displayed, as illustrated in FIG. 3(a). Thereafter, a continue button 305 may be pressed to continue to a next step of the pose estimation process.

A corresponding virtual image of Earth at a viewpoint that approximately corresponds to the pose of the photographic image 303 may be located and displayed next, as reflected by a Locate And Display Corresponding Virtual Image step 203. This may be accomplished, for example, by a user manipulating the user controls 115 and, in response, the computer processing system 113 requesting a virtual image of Earth which corresponds to settings of the user controls 115 from the 3D graphics engine 107. The resulting virtual image may be returned by the 3D graphics engine 107 and displayed on the display 117 next to the selected photographic image.

FIG. 3(b) is a screen that allows a user to locate and display a corresponding virtual image of Earth at a viewpoint that approximately corresponds to the pose of the selected photographic image. It is an example of one approach for the Locate and Display Corresponding Virtual Image step 203.

As illustrated in FIG. 3(b), the photographic image 303 may continue to be displayed, in this instance, in a lower right hand corner of the screen. The display of this photographic image in FIG. 3(b) may be a part of the Display Photographic Image step 201. In other embodiments, there may not be any initial display of the photographic image as illustrated in FIG. 3(a), but the Display Photographic Image step 201 may begin with a screen like that shown in FIG. 3(b).

An interactive map 307 and an icon 308 on that map may be used to locate the corresponding virtual image. The degree of correspondence which may be achieved during this step may only be approximate.

As illustrated in FIG. 3(b), the interactive map 307 may be a 2D image and may be a part of a satellite picture of a larger areas. Such an interactive map may be provided by a variety of services, such as Google Maps and/or Microsoft Virtual Earth.

The interactive map 307 may operate in conjunction with a zoom control 310 that may control its scale. The interactive map 307 may be configured such that it may be dragged by a mouse or other user control and scaled by the zoom control 310 until a large arrow on the icon 308 points to the longitude and latitude of the pose of the photographic image 303. The icon 308 may be rotated by mouse dragging or by any other user control so that it points in the direction of the photographic image, thus establishing the pan of the pose.

During and/or after each movement of the interactive map 307 and/or the icon 308, the computer processing system 113 may send a query to the 3D graphics engine 107 for a virtual image of Earth from the viewpoint specified by the settings of these user controls, i.e., by the dragged position of the interactive map 307 and the dragged rotational position of the icon 308. The computer processing system 113 may be configured to cause the returned virtual image 309 to be interactively displayed. The user may therefore see the effect of each adjustment of the interactive map 307 and the icon 308. This may enable the user to adjust these user controls until the virtual image 309 of Earth appears to be at a viewpoint which best approximates the pose of the photographic image 303. As illustrated in FIG. 3(b), the virtual image 309 and the photographic image 303 may be placed side-by-side in the screen, thus enabling the two to be easily compared by the user during these adjustments.

During the Locate And Display Corresponding Virtual Image step 203, user controls such as an altitude control 311, a tilt control 313, a roll control 315, and/or a zoom control 317 may be provided in the form of sliders or in any other form. One or more of these may similarly be adjusted to make the viewpoint of the virtual image 309 better match the pose of the photographic image 303.

In still other embodiments, the location information concerning the photographic image may be supplied in whole or in part by a GPS device that may have been used when the photographic image was taken, such as a GPS device within the image capture device and/or one that was carried by its user. Similarly, angular orientation information may be provided by orientation sensors mounted within the image capture device at the time the photographic image was taken.

Once the user best matches the viewpoint of the virtual image 309 to the pose of the photographic image 303 using the user controls which have been described and/or different user controls, the continue button 305 may be pressed. This may cause a snapshot of the corresponding virtual image 309 that has now been located to be taken and stored.

In some embodiments, the computer processing system 113 may not have access to 3D data of the corresponding virtual image. In this case, the snapshot may only include 2D data of the corresponding virtual image 309. In other cases, the computer processing system 113 may have access to 3D data of the corresponding virtual image. In this case, the snapshot may include 3D data of the corresponding virtual image 309.

Although having illustrated the Locate And Display Corresponding Virtual Image step 203 as utilizing the interactive map 307, the icon 308, the altitude control 311, the tilt control 313, the roll control 315, and the zoom control 317, a different set of user controls and/or user controls of a different type may be used in addition or instead. For example, the icon 308 may be configured to move longitudinally, as well as to rotate. Similarly, the interactive map 307 may be configured to rotate, as well as to move longitudinally.

In some embodiments, the user controls which are used during this step may not include the altitude control 311, the tilt control 313, the roll control 315, and/or the zoom control 317. For example, the altitude could be presumed to be at eye level (e.g., about five meters), and no altitude control may be provided. In another embodiment, an altitude control may be provided, but set to an initial default of eye level. Similarly, a tilt of zero may be presumed and no tilt control may be provided. In another embodiment, a tilt control may be provided, but set to a default of zero.

User controls other than the interactive map 307 and the icon 308 may be provided to determine the location of the pose and/or the pan. For example, a first-person view may be provided within the 3D environment in which the user may interactively “look around” the space with mouse or keyboard controls mapped to tilt and pan values, Additional controls may be provided for navigating across the surface of the Earth model.

The pose which has thus-far been established by settings of the various user controls may be only approximate. One or more further steps may be taken to enhance the accuracy of this pose, or at least certain of its parameters.

As part of this enhancement process, the photographic image and the corresponding virtual image may be superimposed upon one another, and further adjustments to one or more of the pose parameters may be made, as reflected by an Adjust Pose Of One Image Until It Aligns With Other Image step 205. During this step, either image may be placed in the foreground, and the opacity of the foreground image may be set (or adjusted by a user control not shown) so that both images can be seen at the same time.

FIG. 4 illustrates a process for adjusting the pose of a photographic image and/or a comparable virtual image until the two are aligned. The Adjust Pose Of One Image Until It Aligns With Other Image step 205 may be implemented with the process illustrated in FIG. 4 or with a different process. Similarly, the process illustrated in FIG. 4 may be used to implement an adjustment step other than the Adjust Pose Of One Image Until It Aligns With Other Image step 205.

As an initial part of the Adjust Pose Of One Image Until It Aligns With Other Image step 205, an alignment point on one image may be selected, as reflected by a Select Alignment Point On One Image step 401. As reflected in FIG. 3(c), this step may be implemented by positioning a crosshairs control 321 using a mouse or other user control on a prominent point in the photographic image, such as on an upper corner of a building. After this selection is complete, the continue button 305 may be pressed, causing the coordinates of this alignment point to be saved.

Next, the corresponding alignment point on the other image may be selected, as reflected by a Select Corresponding Alignment Point on Other Image step 403. As illustrated in FIG. 3(d), the other image may be the corresponding virtual image. Another crosshairs control 323 may be positioned using the mouse or other user control at the corresponding point on the corresponding virtual image, such as on the same building corner, as illustrated in FIG. 3(c). Thereafter, the continue button 305 may be pressed, causing the coordinates of the corresponding alignment point also to be stored.

The selection of these alignments points may be in the opposite sequence. Both images may also be displayed on the same screen, rather than on different screens, during this selection process.

The selection of a corresponding point may instead be implemented differently, such as by superimposing one image on top of the other with an opacity of less than 100% and by dragging a point on one image until the point aligns with the corresponding point on the other image.

In any event, both the photographic image and the corresponding virtual image may be displayed overlaid on one another with the selected alignment point on the photographic image and the selected alignment point on the corresponding virtual image overlapping, as indicated by a Display Both Images With Alignment Points Overlapping step 405. An example of such an overlay is illustrated FIG. 3(e), the overlapping alignment points being designated by a crosshair 325. The crosshairs may be implemented using a shape, such as a circle, through which the alternate image appears, as shown in FIG. 3(e). Here, the primary image content may be that of the photographic image, and a circular portion of the virtual image may show through the crosshairs to allow for more accurate comparison of the alignment of the two images. The opposite configuration may also be used. Indicia other than crosshairs may also be used in addition or instead.

At this point in the Adjust Pose Of One Image Until It Aligns With Other Image step 205, the two images may share one point in common, but may not yet be fully aligned due to differences in certain of their posed parameters. For example, the images may have differences in their respective rotations and/or scales. Such a scale difference is illustrated in FIG. 3(e) by the fact that a front roof edge 327 on the photographic image is somewhat below a corresponding front roof edge 329 of the corresponding virtual image.

To compensate for these remaining pose differences, the user interface 111 may be configured to permit the user to click and drag on the foreground image with a mouse pointer or other user control so as to cause the foreground image to rotate and/or scale so that the two images more precisely align, as reflected by a Rotate And Scale One Image To Match Other step 407.

The user interface 111 may be configured to allow the user to find a second set of alignment points, rather than to directly scale and rotate the photographic image. Once the second set of points are selected, the processing system 113 may be configured to performs the same scale-plus-rotate adjustment.

The user interface may be configured to allow more than two sets of alignment points to be selected, following which the processing system 113 may be configured to make the necessary scale-plus-rotate adjustments by averaging or otherwise optimizing differences caused by inconsistencies between the multiple sets of alignment points

The foreground image may have an opacity of less than 100% to facilitate this alignment. A user control may be provided to control the degree of opacity and/or it may be set to a fixed, effective value (e.g., about 50%).

Notwithstanding these efforts, it may not be possible to fully align the two images with respect to one another during the Rotate And Scale One Image To Match Other step 407. This may be attributable to an error made in locating the corresponding virtual image during the initial Locate and Display Corresponding Virtual Image step 203, as illustrated in FIG. 3(b). If this occurs, the user may elect to return to the screen in FIG. 3(b) and revise the position of the interactive map 307, the rotational position of the icon 308, and/or the setting of the altitude control 311 and/or the tilt control 313 to obtain a better alignment, and then repeat the steps illustrated and described above in connection with FIGS. 3(c)-3(e). This may be particularly necessary when the screen illustrated in FIG. 3(e) does not contain any user controls that allow for refinement in the location, altitude, and/or tilt of the pose, such as when the computer processing system 113 only had access to 2D data of the corresponding virtual image 309.

Once a satisfactory level of alignment has been achieved, the continue button 305 may again be pressed. Following this step, the computer processing system 113 may be configured to convert existing settings of the user controls into pose data which is representative of the pose of the photographic image within the 3D model, as reflected by a Convert User Settings to Pose Data step 207. The settings that may be converted may include the settings of the interactive map 307, the icon 308, the altitude control 311, the tilt control 313, the roll control 315, the zoom control 317, and/or the adjustments to some of these settings which were made by the crosshairs controls 321 and 323 and the image dragging control in FIG. 3(e).

The pose data which is created may be created in a format that is compatible with the 3D search engine 107. An example of pose data that may be compatible with the 3D search engine in Google Earth is illustrated in FIG. 3(f).

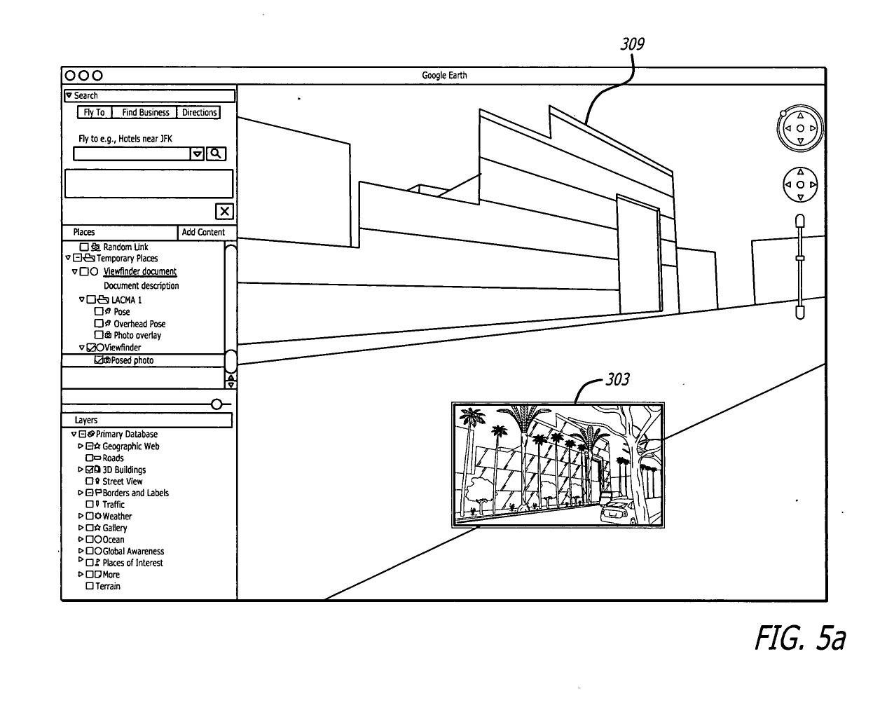

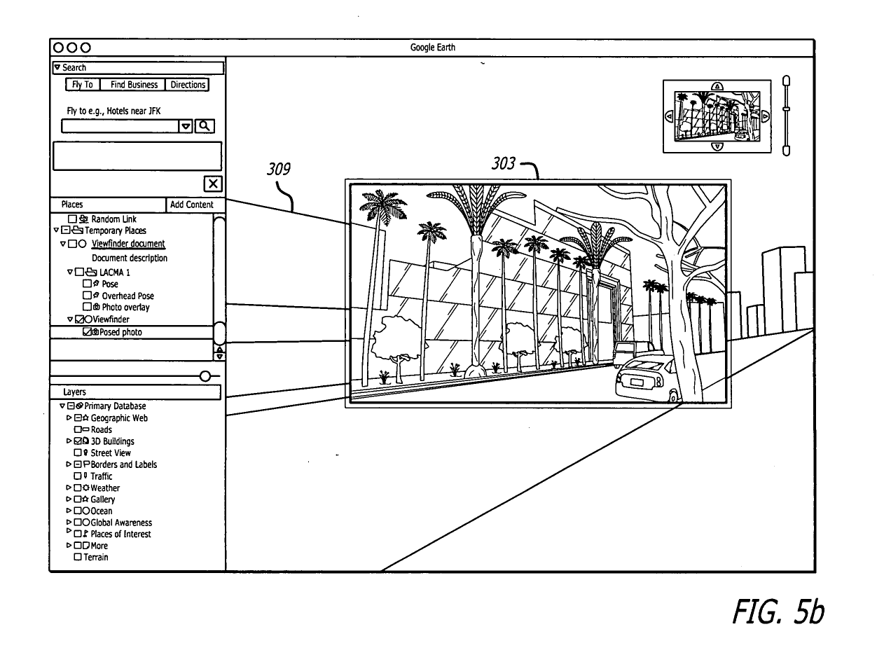

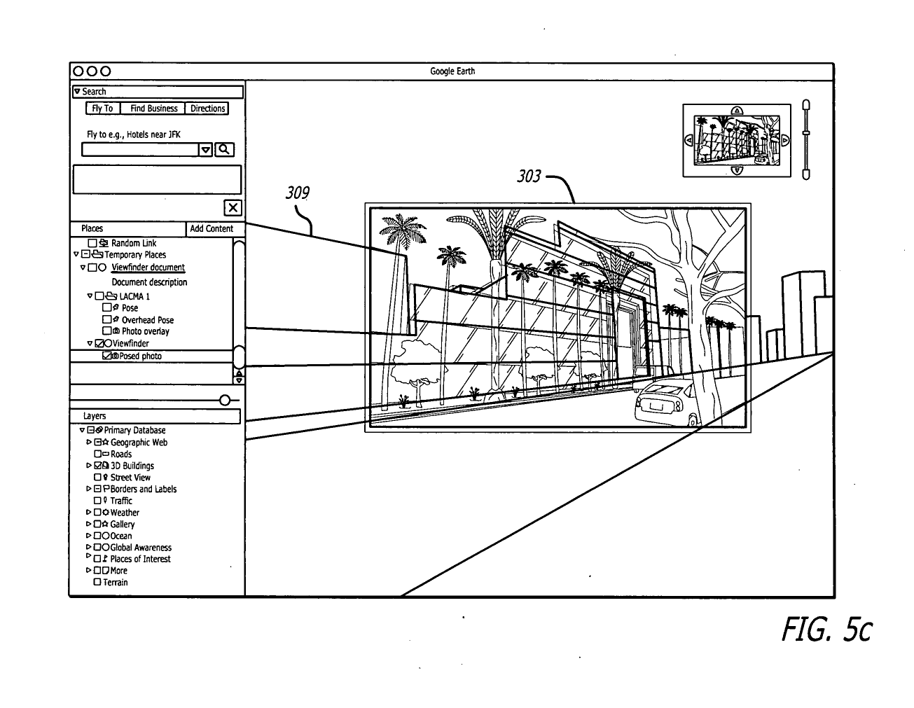

FIGS. 5(a)-5(c) are screens which illustrate a photographic image placed in various ways within a corresponding virtual image. These screens illustrate examples of how the pose data for the photographic image which has been developed may be used to display the photographic image within the 3D model while a user travels through it.

As illustrated in FIG. 5(a), the photographic image 303 may be illustrated in a small window in front of the corresponding virtual image 309. While traveling through this 3D model, a user may click on the photographic image 303, resulting in the display which is illustrated in FIG. 5(b). As illustrated in FIG. 5(b), the photographic image 303 may be sized and placed against the corresponding virtual image 309 such that it appears to be a seamless part of the virtual image 309, except for the greater and/or different detail which the photographic image 303 may provide.

In FIG. 5(b), the photographic image 303 may be set to 100% opacity, covering over all portions of the underlying corresponding virtual image. A user control may be provided (not shown) that enables the user to reduce the opacity of the photographic image 303, thus resulting in a semi-transparent display of the photographic image 303 in its aligned position on top of the corresponding virtual image 309, as illustrated in FIG. 5(c). This may allow a user to compare information in the photographic image with corresponding, underlying information in the corresponding virtual image. This may be useful in connection with historic changes that may have been made between the time the two images were captured, such as the addition or removal of a deck on the building structure.

The presence of various posed photographic images within the 3D model may be signified to a user while travelling through the 3D model in many ways other than as illustrated in FIG. 5(a). Examples of this are illustrated and discussed in U.S. patent application Ser. No. 11/768,732, entitled, “Seamless Image Integration into 3D Models,” filed Jun. 26, 2007, attorney docket no. 028080-0277, the entire content of which is incorporated herein by reference.

The process example illustrated in FIGS. 3(c)-3(e) may be well suited for when the computer processing system 113 only has access to 2D data that is representative of the corresponding virtual image. When the computer processing system 113 has access to 3D data that is representative of the corresponding virtual image, on the other hand, a different approach may be preferable for the Adjust Pose Of One Image Until It Aligns With Other Image step 205.

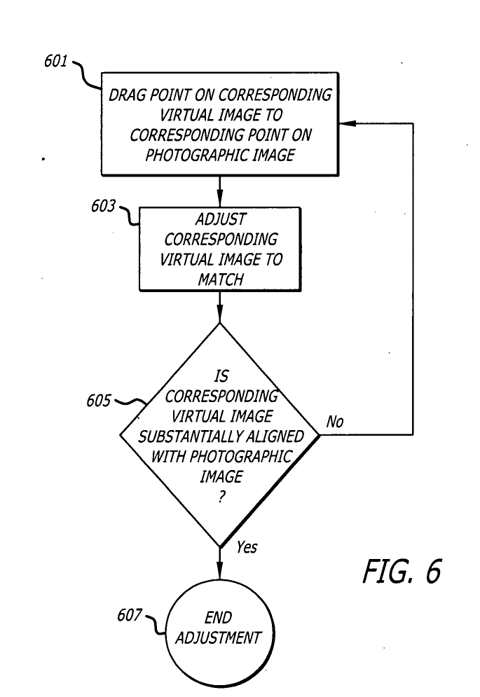

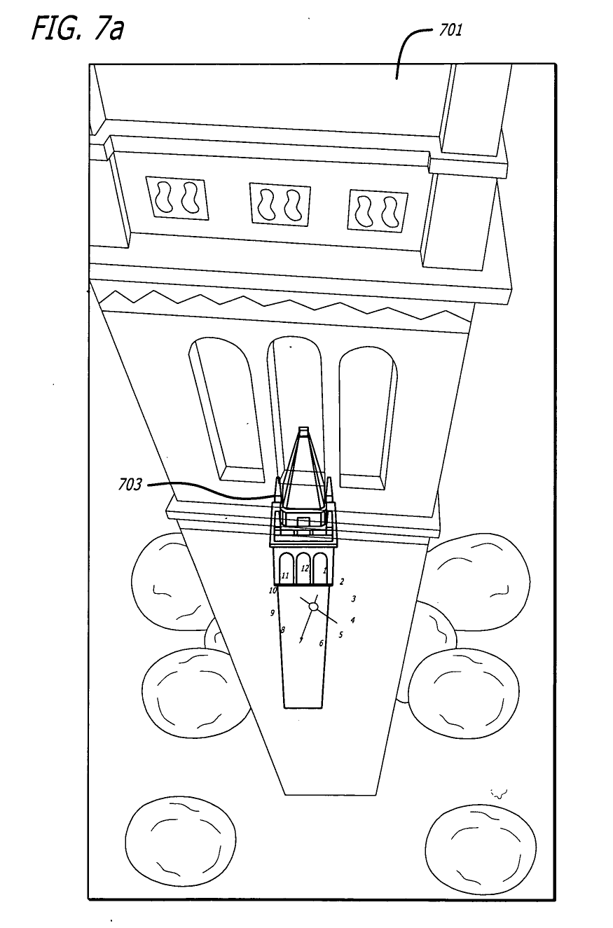

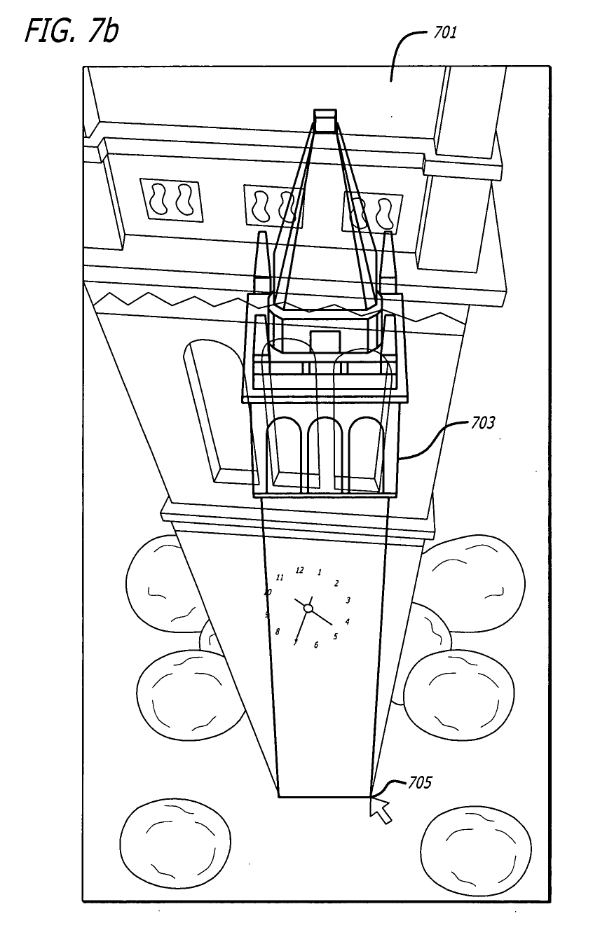

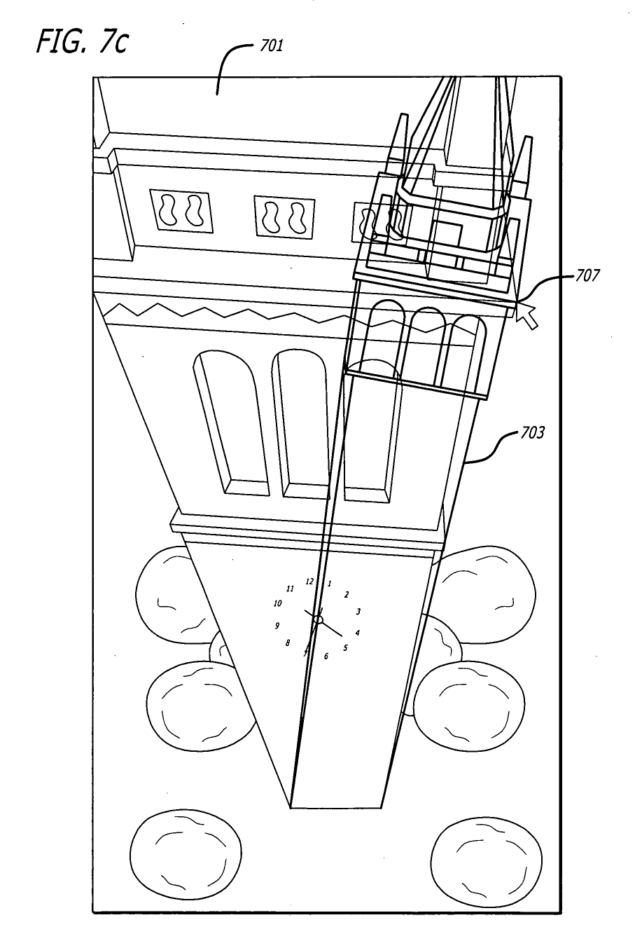

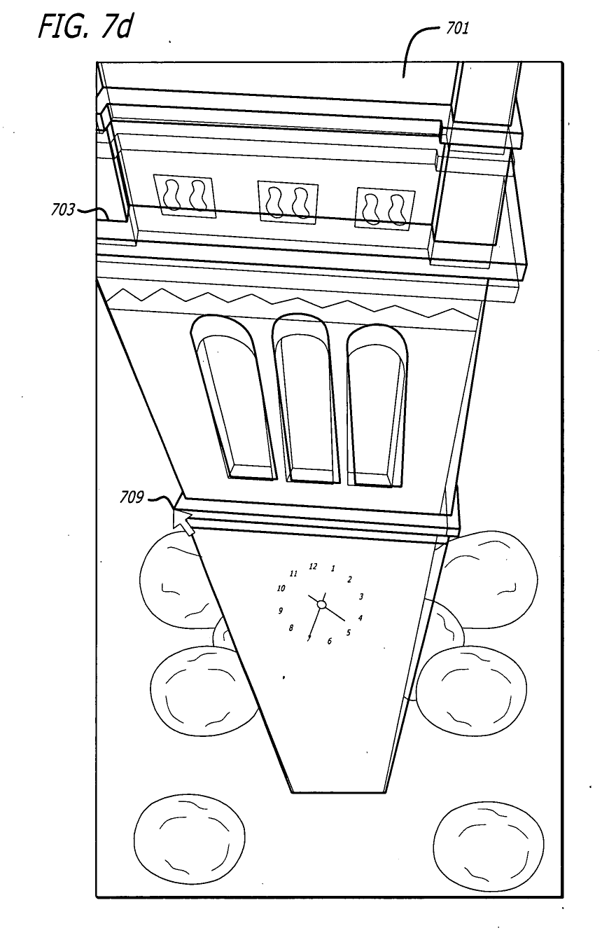

FIG. 6 illustrates an alternate process for adjusting the pose of a photographic image and/or a comparable virtual image until the two are aligned. FIGS. 7(a)-(d) are screens which illustrate a portion of an alternate pose estimation process. The process illustrated in FIG. 6 may be implemented with the screens illustrated in FIGS. 7(a)-7(d) or with different or additional screens. Similarly, the screens illustrated in FIGS. 7(a)-(d) may implement processes other than the one illustrated in FIG. 6.

FIG. 7(a) is an example of what the screen may look like after the Locate and Display Corresponding Virtual Image step 203 when the computer processing system 113 was provided 3D data of the corresponding virtual image. As illustrated in FIG. 7(a), the photographic image 701 of a bell tower may be displayed underneath the corresponding virtual image 703 which was located during the Locate and Display Corresponding Virtual Image step 203. As illustrated in FIG. 7(a), the viewpoint of the corresponding virtual image 703 may be similar to the pose of the photographic image 701, but may still have noticeable differences, including noticeable differences in scale and elevation.

To correct for these differences, a point on the corresponding virtual image may be clicked with a mouse or other user control and dragged to a corresponding point on the photographic image, as illustrated in FIG. 7(b). As illustrated in FIG. 7(b), the lower right corner 705 of the bell tower has been selected on the corresponding virtual image and dragged to the corresponding lower right corner of the bell tower in the photographic image. This is reflected in FIG. 6 as a Drag Point on Corresponding Virtual Image to Corresponding Point on Photographic Image step 601.

After this step, the computer processing system 113 may be configured to re-compute the viewpoint of the corresponding virtual image based on the initial and final location of the dragged mouse pointer and to redisplay the adjusted corresponding virtual image, as illustrated in FIG. 7(b). This is also indicated as an Adjust Corresponding Virtual Image to Match step 603 in FIG. 6.

Although this may have caused the scale of the corresponding virtual image 703 to more closely approximate the scale of the photographic image 701, the altitude of the poses of both images remains substantially different. The user may then decide whether the viewpoint of the virtual image 703 sufficiently matches the pose of the photographic image 701, as reflected by a Is Corresponding Virtual Image Substantially Aligned With Photographic Image? step 605.

If it is not sufficient, the user may select another point on the corresponding virtual image and drag it to the corresponding point on the photographic image 701. As illustrated in FIG. 7(c), for example, user may select the front right corner of a ledge on the corresponding virtual image 703 and drag it to the corresponding point on the photographic image 701.

The computer processing system 113 may again re-compute the viewpoint of the corresponding virtual image based on the initial and final location of the dragged mouse pointer and again redisplay the adjusted corresponding virtual image, as illustrated in FIG. 7(c).

Again, the user may decide whether the accuracy of the viewpoint is sufficient, as reflected in the Corresponding Virtual Image Substantially Aligned With Photographic Image? step 605. If it is not, the user may again select and drag another point on the corresponding virtual image 703 to its corresponding point on the photographic image 701, such as a front left corner of a lower ledge, as illustrated in FIG. 7(d). Again, the computer processing system 113 may re-compute the viewpoint of the corresponding virtual image based on the initial and final location of the dragged mouse pointer and again redisplay the adjusted corresponding virtual image, as illustrated in FIG. 7(d).

The user may repeat this process until the user is satisfied with the accuracy of the viewpoint of the corresponding virtual image.

The process which has been discussed in connection with FIGS. 7(a)-7(d) may proceed based on a rough approximation of the camera intrinsic parameters: focal length and center of projection (e.g., from the EXIF information saved in the picture when it was taken).

If at least eight “good” correspondences between the real picture and the virtual picture are specified, the classical “eight-point” algorithm from computer vision may be used to retrieve the geometry of this “stereo couple” up to a single unknown transformation using only the given matches. See Hartley, Richard and Zisserman, Andrew, Multiple View Geometry in Computer Vision, Cambridge: Cambridge University Press (2003) Given that depth values of the points are available, this ambiguity may be removed and a metric reconstruction may be obtained, i.e. the parameters computed (such as translation and rotation of the camera) are an accurate representation of reality.

In practice, various errors may occur, such as when the number of corresponding points is less than the minimum required or when they do not contain enough varied depth information in aggregate, for example, if more than one point is co-planar with another point. The problem may be under-constrained, and so not enough information may be available to infer a solution.

The approach which was earlier described may rely on the ability of a human user to detect matching features (points, lines) between two (real-virtual) images of the same scene. User-controls may interactively refine information provided by the human user. This input may be used artificially to constrain the problem, enabling the pose of the camera and its projection parameters to be automatically optimized.

The artificial constraint may be based on the assumption that the pose found by the user is close to the real one. The lack of mathematical constraints may be compensated by forcing a parameter search to take place within the locale of the human guess. The optimization result may get closer and closer to the right one as long as the user provides further correct matchings. This may cause the amount of information to be increased incrementally, thus improving the quality of the output. Moreover, the interactive nature of the approach allows the results of the step-by-step correction to be seen in real time, allowing the user to choose new appropriate matches to obtain a better pose.

A fast, natural, and intuitive interface may be used in which the user can see the picture overlayed to the model, change the point of view from which the model is observed, and add or modify correspondences between features in the real and in the virtual picture simply by dragging points and/or lines and dropping them on the expected position. During each drag-and-drop operation, the optimization engine may gather all the available matches, launch the minimization process, and show the results in few instants. The result of the step-by-step correction may be seen “online,” giving the user immediate feedback and allowing him or her to correct or choose appropriate matches to improve the pose of the picture.

By providing an intuitive, straightforward interface, a user community may become increasingly skilled and fluent performing the tasks required.

The optimization problem may be defined by the objective function to be minimized, and by the constraints that any feasible solution must respect. The function may be a second-order error computed from all the matches. Each term may be the square of the distance on the camera image plane between the real feature and the re-projection of the virtual feature's position, where the latter may be dependent on the camera parameters being sought.

The solution may lie close to the one provided by the user. To achieve this, another parameter may control how the solution progresses when the solution is far from the initial estimate. This may force the optimization algorithm to find a solution as close as possible to the estimate. In practice, the Levenberg-Marquardt optimization algorithm, see Press, William H.; Teukolsky, Saul A.; Vetterling, William T.; and Flannery, Brian P.; Numerical Recipes: The Art of Scientific Computing. Cambridge: Cambridge University Press (2007), may work well for the target function. Existing techniques are described in Facade Paul E. Debevec, Camillo J. Taylor, and Jitendra Malik, Modeling and Rendering Architecture from Photographs: A Hybrid Geometry and Image-Based Approach, Proceedings of SIGGRAPH 96 (August 1996) and Canoma, U.S. Pat. No. 6,421,049, “Parameter selection for approximate solutions to photogrammetric problems in interactive applications”, Issued on Jul. 16, 2002, Gang Deng and Wolfgang Falg, An Evaluation of an Off-the-shelf Digital Close-Range Photogrammetric Software Package, Photogrammetric Engineering & Remote Sensing Vol. 67, No. 2, February 2001, pp. 227-233. Unlike these techniques, only camera parameters may be optimized. This allows the optimization to converge rapidly.

Automatic techniques that mix with heuristics, may compute the vanishing points from the scene.

Due to perspective deformations, lines parallel in the real world may be imaged as incidents on the image plane of the camera at a point that is typically quite distant from the center of projection. Such points may be called vanishing points and are essentially the projection of real world directions onto the image plane of the camera.

Given the vanishing points for three orthogonal directions in any given scene, straightforward computer vision techniques may be used to compute the orientation of the camera.

Computing the orientation in this way may reduce the number of parameters involved in the optimization process, thus reducing the number of matches required to pose the picture. This feature may therefore be useful, especially when posing pictures of buildings with predominantly straight lines.

All articles, patents, patent applications, and other documents which have been cited in this application are incorporated herein by reference.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

For example, onboard sensing devices in cameras such as GPS units, gyro sensors, and accelerometers may help the human assistant by providing some of the information required for pose estimation, thus making the job easier. Also, various forms of rendering the virtual image from the 3D model, including higher resolution renderings such as edge-enhanced virtual images and lower resolution renderings such as wireframe-only images, may result in making the human assistance easier than conventional rendering for certain kinds of imagery. Multiple photographic images may be posed and viewed together intentionally, for example to tell a story or play a game.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The phrase “means for” when used in a claim is intended to and should be interpreted to embrace the corresponding structures and materials that have been described and their equivalents. Similarly, the phrase “step for” when used in a claim embraces the corresponding acts that have been described and their equivalents. The absence of these phrases means that the claim is not intended to and should not be interpreted to be limited to any of the corresponding structures, materials, or acts or to their equivalents.

Nothing that has been stated or illustrated is intended or should be interpreted to cause a dedication of any component, step, feature, object, benefit, advantage, or equivalent to the public, regardless of whether it is recited in the claims.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

1. A pose estimation system for estimating the pose of a photographic image of a portion of Earth comprising:
a 3D graphics engine for rendering a virtual image of Earth from a controllable viewpoint based on 3D data that is representative of a 3D model of at least a portion of Earth;
a computer user interface that includes a display and user controls having settings that can be set by a user; and
a computer processing system associated with the 3D graphics engine and the computer user interface,
wherein the computer processing system and the user interface are configured to:
display the photographic image on the display;
allow the user to locate and display on the display a corresponding virtual image of Earth at a viewpoint that approximately corresponds to the pose of the photographic image by manipulating the user controls and by using the 3D graphics engine;
display the photographic image and the corresponding virtual image overlaid on one another so that both images can be seen at the same time;
allow the user to adjust the pose of one of the images while overlaid on the other image by manipulating the user controls so that both images appear to substantially align with one another; and
convert settings of the user controls to pose data that is representative of the pose of the photographic image within the 3D model.

2. The pose estimation system of claim 1 further comprising a computer storage system containing the 3D data.

3. The pose estimation system of claim 2 wherein the computer storage system also contains the photographic image and wherein the photographic image includes information not contained within the corresponding virtual image.

4. The pose estimation system of claim 3 wherein the photographic image is sufficiently different from the corresponding virtual image that it would be very difficult to ascertain the pose of the photographic image within the 3D model based on by automation alone.

5. The pose estimation system of claim 1 wherein the computer processing system does not have access to a 3D version of the corresponding virtual image.

6. The pose estimation system of claim 1 wherein the user interface and the computer processing system are configured to present the user with a location-selection screen on the display which in one area displays the photographic image and in another area displays a virtual image of Earth at the pose dictated by settings of the user controls while the user is trying to locate the corresponding virtual image of the photographic image by manipulating the user controls.

7. The pose estimation system of claim 6 wherein the user controls include an interactive 2D map of at least a portion of the 3D model and an icon on the interactive map in the location-selection screen and wherein the user interface and the computer processing system are configured to allow the user to locate the corresponding virtual image by moving the interactive map relative to the icon.

8. The pose estimation system of claim 7 wherein the user interface and the computer processing system are configured to allow the use to specify the pan of the corresponding virtual image by rotating the icon relative to the interactive map.

9. The pose estimation system of claim 6 wherein the user interface and the computer processing system are configured to present the user with a photo-point selection screen on the display and to allow the user to select and store an alignment point on a displayed image of the photographic image.

10. The pose estimation system of claim 9 wherein the user interface and the computer processing system are configured to present the user with a virtual-point selection screen on the display and to allow the user to select and store an alignment point on a displayed image of the corresponding virtual image.

11. The pose estimation system of claim 10 wherein the user interface and the computer processing system are configured to display the photographic image and the corresponding virtual image overlaid on one another with the selected alignment points on the photographic image and the corresponding virtual image overlapping.

12. The pose estimation system of claim 11 wherein the user interface and the computer processing system are configured to allow the user to rotate and scale one image with respect to the other image by manipulating settings of the user controls while the selected alignment points overlap so as to better align the two images.

13. The pose estimation system of claim 1 wherein the user interface and the computer processing system are configured to allow the user to separately drag each of a plurality of points on the corresponding virtual image to a corresponding point on the photographic image while the two images are overlaid on one another so as to cause the two images to better align with one another after each point is dragged by the user.

14. The pose estimation system of claim 13 wherein the user interface and the computer processing system are configured to allow the user to drag each of the plurality of points until the overlaid images are substantially aligned with one another.

15. Computer-readable storage media containing computer-readable instructions which, when read by a computer system containing a 3D graphics engine, a computer user interface, and a computer processing system, cause the computer system to implement the following process for estimating the pose of a photographic image of a portion of Earth:
displaying the photographic image on a display;
locating and displaying a corresponding virtual image of Earth on the display at a viewpoint that approximately corresponds to the pose of the photographic image by manipulating user controls;
displaying the photographic image and the corresponding virtual image overlaid on one another so that both images can be seen at the same time;
adjusting the pose of the one of the images while overlaid on the other image by manipulating the user controls so that both images appear to substantially align with one another; and
converting settings of the user controls to pose data that is representative of the pose of the photographic image within the 3D model.

16. The computer-readable storage media of claim 15 wherein the photographic image includes information not contained within the corresponding virtual image.

17. The computer-readable storage media of claim 16 wherein the corresponding virtual image is located at least in part by human comparison between the photographic image and the corresponding virtual image.

18. The computer-readable storage media of claim 15 wherein the locating includes displaying the photographic image in one area of the display and a virtual image of Earth at the viewpoint dictated by settings of the user controls in another area of the display while the user manipulates the user controls.

19. The computer-readable storage media of claim 18 wherein the locating includes moving an interactive 2D map of at least a portion of the 3D model relative to an icon on the interactive map.

20. The computer-readable storage media of claim 19 wherein the locating includes rotating the icon relative to the interactive map.

21. The computer-readable storage media of claim 18 further comprising selecting and storing an alignment point on a displayed image of the photographic image.

22. The computer-readable storage media of claim 21 further comprising selecting and storing an alignment point on a displayed image of the corresponding virtual image.

23. The computer-readable storage media of claim 22 wherein the displaying step includes displaying the photographic image and the corresponding virtual image such that the selected alignment points on the photographic image and the corresponding virtual image overlap.

24. The computer-readable storage media of claim 23 wherein the adjusting the pose step includes rotating and scaling one image with respect to the other image by manipulating settings of the user controls while the selected alignment points overlap.

25. computer-readable storage media of claim 15 wherein adjusting the pose step includes separately dragging each of a plurality of points on the corresponding virtual image to a corresponding point on the photographic image while the two images are overlaid on one another so as to cause the two images to better align with one another after each point is dragged.

26. The computer-readable storage media of claim 25 wherein the adjusting the pose step includes dragging each of the plurality of points until the overlaid images are substantially aligned with one another.

27. A pose estimation process for estimating the pose of a photographic image of a portion of Earth comprising:
displaying the photographic image on a display;
locating and displaying a corresponding virtual image of Earth on the display at a viewpoint that approximately corresponds to the pose of the photographic image by manipulating user controls;
displaying the photographic image and the corresponding virtual image overlaid on one another so that both images can be seen at the same time;
adjusting the pose of the one of the images while overlaid on the other image by manipulating the user controls so that both images appear to substantially align with one another; and
converting settings of the user controls to pose data that is representative of the pose of the photographic image within the 3D model.
